(19) United States
(12) Patent Application Publication
(10) Pub. No.: US 2014/0300531 A1
(43) Pub. Date: Oct. 9, 2014

(54) INDICATOR INPUT DEVICE WITH IMAGE RECOGNITION FUNCTION

(71) Applicant: DEXIN CORPORATION, New Taipei City (TW)

(72) Inventor: CHING-TSUN HONG, NEW TAIPEI CITY (TW)

(73) Assignee: Dexin Corporation, New Taipei City (TW)

(21) Appl. No.: 13/856,447

(22) Filed: Apr. 4, 2013

(51) Int. Cl. G06F 3/00

(52) U.S. Cl. CPC G06F 3/005
USPC 345/156

(57) ABSTRACT

An indicator input device with image recognition function is used to control the indicator movement displayed on a host. The device includes a body, a displacement sensing unit, an image recognition unit, and a control unit. The displacement sensing unit detects the body movement. The image recognition unit is installed on the body. The control unit is coupled to the displacement sensing unit and the image recognition unit, and generates an indicator control signal to control the movement of the indicator according to the detection result of the displacement sensing unit, and generates an operation instruction corresponding to a body action according to the image recognition result of the image recognition unit.

### BACKGROUND OF THE INVENTION

1. Field of the Invention

The present invention relates to an indicator input device; in particular, to an indicator input device with image recognition function.

2. Description of Related Art

Accompanied with the development of electronic equipments, some input devices such as keyboard, mouse and touch panel are sequentially used for solving some input problems confronted by a user.

Due to enhancement of computer operation capability and diffusion of Graphic User Interface (GUI), a user should use a mouse to conveniently operate a computer device of a GUI, thus the mouse is a very important input device when a computer is used.

Compared with using an input device such as a conventional keyboard to operate a computer, a mouse can provide a more intuitive and convenient operation mode. When a user moves a mouse, the indicator displayed on a host will move according to the movement of the mouse so long as the user places his/her fingers on the mouse. In addition, when the user operates the mouse with a hand, the user cannot control the mouse operation at his/her own will due to the fact that a hand must contact the mouse practically.

### SUMMARY OF THE INVENTION

The object of the present invention is to provide an indicator input device with image recognition function. The indicator input device is used for controlling the movement of an indicator displayed on a host, and includes a body, a displacement sensing unit, an image recognition unit, and a control unit. The displacement sensing unit is used for detecting the movement of the body. The image recognition unit is installed on the body. The control unit is coupled to the displacement sensing unit and the image recognition unit, and generates an indicator control signal to control the movement of the indicator according to the detection result of the displacement sensing unit, and generates an operation instruction corresponding to a body action according to the image recognition result of the image recognition unit.

When a user uses an indicator input device, the movement of the indicator displayed on the host is controlled through the sensing result of the displacement sensing unit by moving the indicator input device, so as to perform a contact input operation; or an operation instruction is relatively generated through recognizing a body action performed by an image recognition unit of the indicator input device, so as to perform a non-contact input operation.

Summing up the above, the indicator input device in an embodiment of the present invention provides simultaneously two different input modes, i.e., a contact control input and a non-contact control input, so as to enhance the operation convenience of the indicator input device.

In order to further the understanding regarding the present invention, the following embodiments are provided along with illustrations to facilitate the disclosure of the present invention. However, the description and drawings are merely provided for reference and illustration, without any intention to be used for limiting the present invention.

### BRIEF DESCRIPTION OF THE DRAWINGS

FIG. 1 shows a block diagram of an indicator input device according to an embodiment of the present invention;

FIG. 2 shows a schematic diagram of an indicator input device according to an embodiment of the present invention;

FIG. 3 shows a block diagram of an indicator input device according to another embodiment of the present invention;

FIG. 4 shows a schematic diagram of an indicator input device according to another embodiment of the present invention;

FIG. 5 shows a flow chart for determining an operation mode of an indicator input device according to an embodiment of the present invention;

FIG. 6A shows a schematic diagram for performing a contact operation of an indicator input device according to an embodiment of the present invention;

FIG. 6B shows a schematic diagram for performing a non-contact operation of an indicator input device according to an embodiment of the present invention.

### DETAILED DESCRIPTION OF THE PREFERRED EMBODIMENTS

The aforementioned illustrations and following detailed descriptions are exemplary for the purpose of further explaining the scope of the present invention. Other objects and advantages related to the present invention will be illustrated in the subsequent descriptions and appended drawings.

### Embodiment of an Indicator Input Device

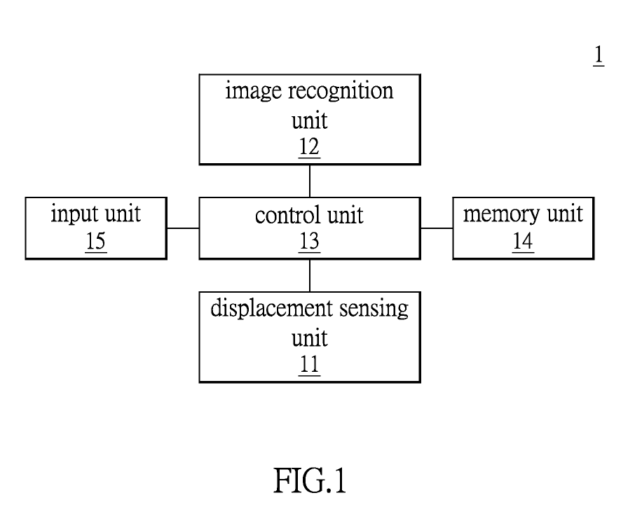

Please refer to FIG. 1. FIG. 1 shows a block diagram of an indicator input device according to an embodiment of the present invention. In the embodiment, except that the indicator input device 1 can control the movement of the indicator displayed on a host (not shown) by means of a contact input operation, the indicator input device can further control the host to execute an operation instruction by means of a non-contact input operation. The indicator input device 1 includes a displacement sensing unit 11, an image recognition unit 12, a control unit 13, a memory unit 14, and an input unit 15. The control unit 13 is coupled to the displacement sensing unit 11, the image recognition unit 12, the memory unit 14 and the input unit 15.

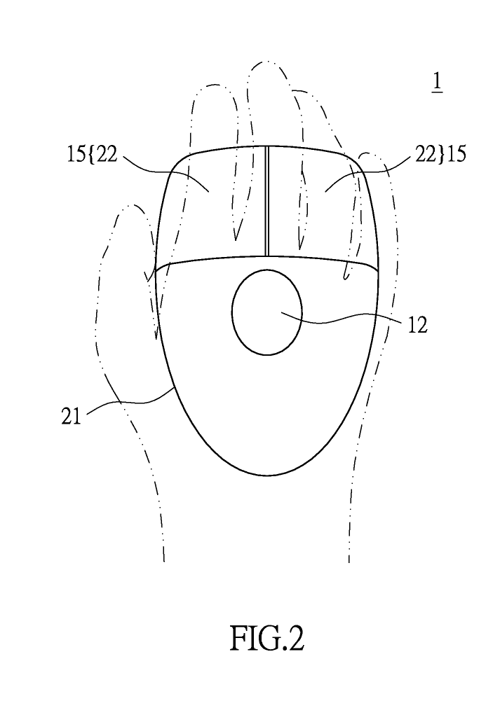

Please refer to FIG. 1 and FIG. 2. FIG. 2 shows a schematic diagram of an indicator input device according to an embodiment of the present invention. In this embodiment, the indicator input device 1 shown in FIG. 2 includes a body 21, on which an input unit 15 and an image recognition unit 12 are installed.

As shown in FIG. 2, the input unit 15 includes a button 22 for providing a left and a right key function of a conventional mouse. In this embodiment, the indicator input device 1 has a left and a right key, whereas in other embodiments the indicator input device 1 may have one or several keys. In summary, the number and function of the button 22 of the indicator input device 1 are not used for limiting the present invention.

As shown in FIG. 1 and FIG. 2, the displacement sensing unit 11 (not shown in FIG. 2) is located under the body 21 of the indicator input device 1 and is used for detecting the movement of the body 21. The image recognition unit 12 is installed on the body 21 and is used for detecting a body action of a user. The control unit 13 generates an indicator control signal to control the indicator movement according to the detection result of the displacement sensing unit 11, and generates an operation instruction corresponding to a body action according to the image recognition result of the image recognition unit 12. The memory unit 14 stores a contrast table, and the contrast table records a corresponding relationship between the body action and the operation instruction. For example, the operation instruction is outputted to a host and controls the host to perform an input operation. The input operation may be, for example, used for controlling the output picture of the host so as to perform a display and control function such as displaying previous page, next page, scrolling, amplification and/or contraction. In addition, it is worth noting that the operation mode corresponding to the operation instruction for controlling the host to perform an operation is not limited thereto, and can be set practically according to an operation requirement of a user for a host.

Speaking furthermore, the indicator input device 1 of this embodiment performs a non-contact input operation by means of the image recognition unit 12. Supposing that a user wishes to input an operation instruction to a host through the image recognition unit 12, the user can place the hand to be located above the image recognition unit 12 as shown in FIG. 2, and the hand will not touch the body 21, thus the image recognition unit 12 can recognize an image input of a body action such as fingers or gestures etc, and queries the memory unit 14 according to the image recognition result, so as to generate an operation instruction corresponding to the image input. Speaking simply, in the non-contact input operation of this embodiment, a user is permitted to operate in a body-sensing manner the indicator input device 1.

On the contrary, the indicator input device 1 of this embodiment can perform a contact input operation by means of the displacement sensing unit 11. Supposing that a user wishes to perform a contact input operation by means of the displacement sensing unit 11, the user can place the hand to be located on the body 21 of the indicator input device 1, and touches and moves the body 21 with hand as shown in FIG. 2, then the displacement sensing unit 11 can detect the movement of the body 21, and generates an indicator control signal to the host to control the indicator movement according to the detection result, at the same time the user can perform an operation by pressing the button 22, as operated by a general mouse.

By the way, the button 22 is a mechanical micro-switch, an inductive sensor, or a pressure sensor of other types. In summary, an implementation type of the button 22 is not used to limit the present invention.

Besides, the input unit 15 of the indicator input device 1 may be further provided with a scrolling roller (not shown in FIG. 2), so as to let the user facilitate to perform a scrolling operation of a host display screen.

The displacement sensing unit 11 of the indicator input device 1 may be a mechanical rolling ball or an optical sensor. The implementation type of the displacement sensing unit 11 is not used to limit the present invention.

The image recognition unit 12 of the indicator input device 1 is a CMOS sensor, a CCD sensor, an infrared sensor, or other image sensors or a combination thereof. The implementation type of the image recognition unit 12 is not used to limit the present invention.

Moreover, the indicator input device 1 and the host may be connected mutually through wired or wireless mode. The indicator input device 1 may be wiredly connected to the host through cables, whereas the indicator input device 1 may be wirelessly connected to the host through wireless technology such as radio frequency, infrared (IR) and Bluetooth. The connection type between the indicator input device 1 and the host is not used to limit the present invention.

Please note that the outline of the indicator input device 1 and each member on the body 21 are not used to limit the present invention.

### Another Embodiment of the Indicator Input Device

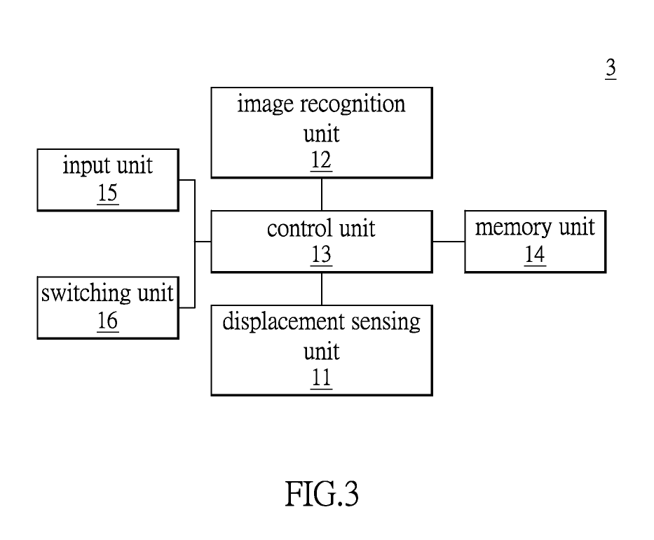

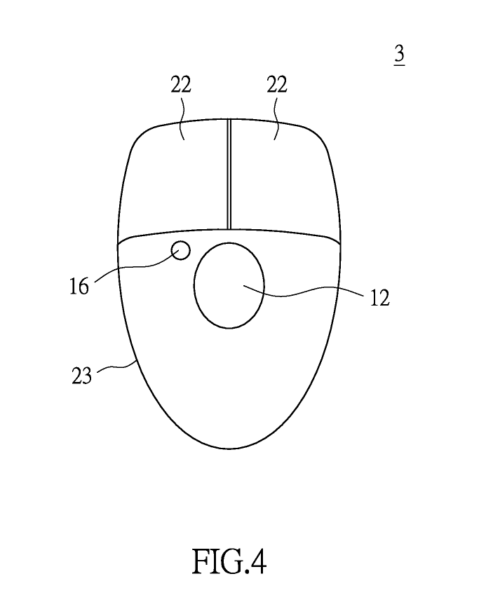

Please refer to FIG. 3 and FIG. 4. FIG. 3 shows a block diagram of an indicator input device according to another embodiment of the present invention. FIG. 4 shows a schematic diagram of an indicator input device according to another embodiment of the present invention. Compared with FIG. 1 and FIG. 2, the indicator input device 3 of FIG. 3 and FIG. 4 further includes a switching unit 16. The switching unit 16 is located on the body 23 of the indicator input device 3 and is coupled to the control unit 13. The control unit 13 may relatively control the image recognition unit 12 to be enabled or disabled according to a switching signal outputted by the switching unit 16, wherein the switching unit 16 may be a switch, a switching button, a distance sensor or a light detector, whereas it must be noted that the implementation type of the switching unit 16 of the present invention is not limited thereto.

For example, when the switching unit 16 is a switch or a switching button, the user can directly control the switch or the switching button, i.e., the switching unit 16 lets the user control manually the image recognition unit 12 to be enabled or disabled directly. For example, when the user switches the switch or the switching button to an enabled state, the switch or the switching button will send a switching signal representing an enabling to the control unit 13, and the image recognition unit 12 is controlled by the control unit 13 to be enabled. On the contrary, when the user switches the switch or the switching button to a disabled state, the switch or the switching button will send a switching signal representing a disabling to the control unit 13, and the image recognition unit 12 is controlled by the control unit 13 to be disabled.

When the switching unit 16 is a distance sensor or a light detector, the switching unit 16 can detect automatically the operation mode of a user and correspondingly controls the image recognition unit 12 to be enabled or disabled.

Supposing that the switching unit 16 is a distance sensor, the switching unit 16 will output an enabling switching signal to the control unit 13 when the hand of the user is located within an operable predetermined distance range above the image recognition unit 12. At this moment, the control unit 13 will control the image recognition unit 12 to be enabled; on the contrary, the switching unit 16 will output a disabling switching signal to the control unit 13 when the hand of the user is located outside an operable predetermined distance range above the image recognition unit 12. At this moment, the control unit 13 will control the image recognition unit 12 to be disabled.

Supposing that the switching unit 16 is a light detector, the switching unit 16 will output an enabling switching signal to the control unit 13 when the hand of the user does not contact the body 23, i.e., does not cover the light detector. At this moment, the control unit 13 will control the image recognition unit 12 to be enabled; on the contrary, the switching unit 16 will output a disabling switching signal to the control unit 13 when the hand of the user contacts the body 23 and covers the light detector. At this moment, the control unit 13 will control the image recognition unit 12 to be disabled.

### Embodiment of Turning on a Non-Contact Control Mode by the Indicator Input Device

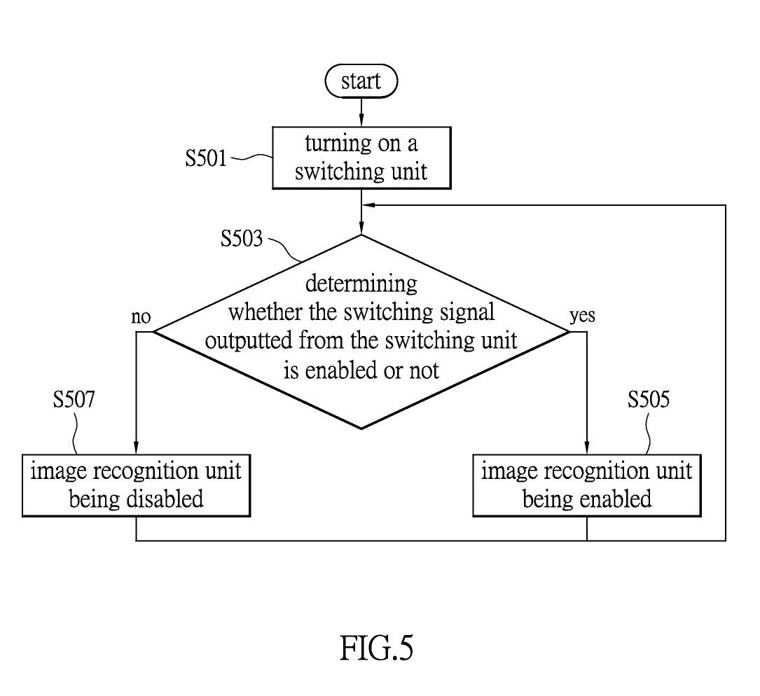

Please refer to FIG. 3, FIG. 4 and FIG. 5. FIG. 5 shows a flow chart for determining an operation mode of an indicator input device according to an embodiment of the present invention. At first, in step S501, when the indicator input device 3 is turned on, the switching unit 16 of the indicator input device 3 is activated, so that the switching unit 16 can correspondingly generate an enabling or a disabling switching signal according to a user's operation. Next, in step S503, the control unit 13 of the indicator input device 3 determines whether the switching signal outputted by the switching unit 16 is enabled or not. If the switching signal is enabled, then step S505 is performed; if the switching signal is not enabled, then step S507 is performed.

In step S505, the image recognition unit 12 of the indicator input device 3 is enabled, i.e., a user can perform a non-contact input operation for the indicator input device 3 by means of the image recognition unit 12. In step S507, the image recognition unit 12 of the indicator input device 3 is disabled, i.e., a user can perform only a contact input operation for the indicator input device 3. After step S505 and step S507, it goes back to step S503 and performs continuously until the indicator input device 3 is turned off.

In the step S501, the switching unit 16 may be a switch, a switching button, a distance sensor, a light detector or other sensors, while “how the switching unit 16 switches the output of a switching signal” may be referred in the FIG. 4 for illustration.

### Usage Embodiment of the Indicator Input Device in a Computer Device

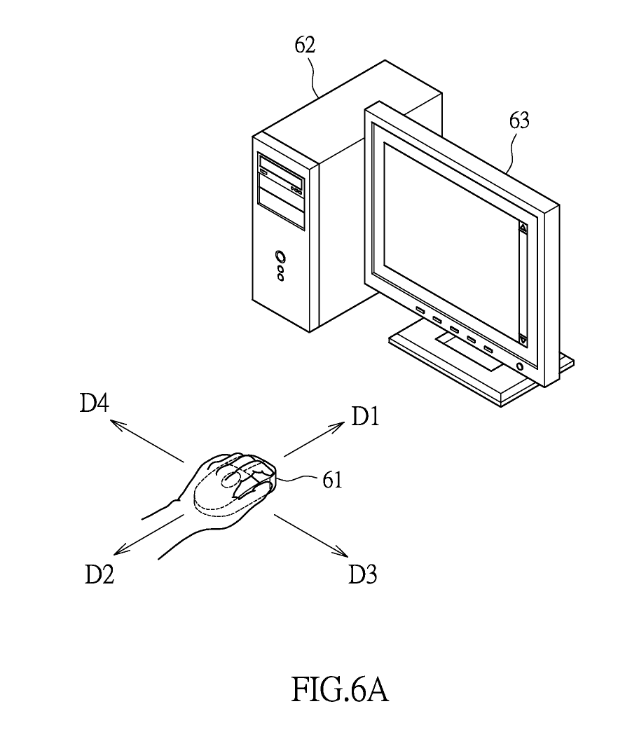

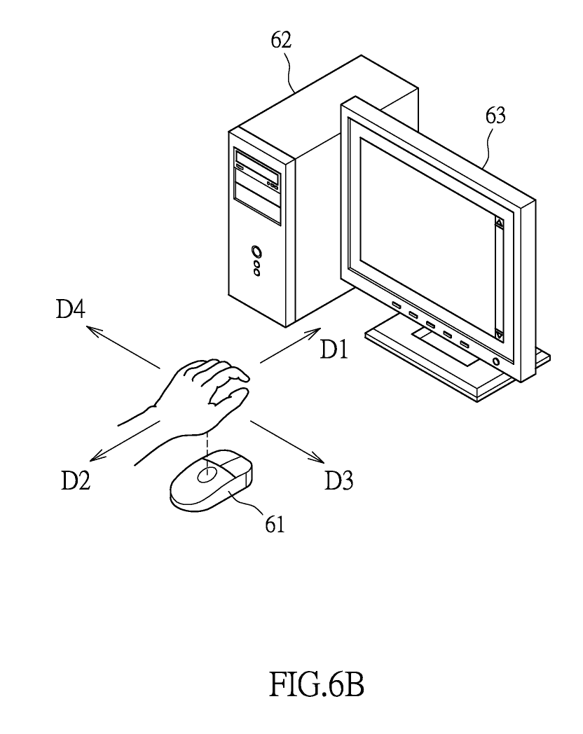

Please refer to FIGS. 6A and 6B. FIGS. 6A and 6B show respectively a schematic diagram for performing a contact and a non-contact operation of an indicator input device according to an embodiment of the present invention. A computer device may include an indicator input device 61, a computer host 62 and a computer screen 63. A user uses the indicator input device 61 to perform an input for the computer device.

Please refer to FIG. 6A. When a user directly contacts the body of the indicator input device 61 to perform a conventional mouse operation, the user may place the hand to be located above the indicator input device 61. At this moment the indicator input device 61 performs a contact input operation due to the fact that the hand of the user directly contacts the upper surface of the indicator input device 61. Therefore, the indicator of the output picture on the computer screen 63 will perform a corresponding movement according to the movement of the body of the indicator input device 61. For example, when a user operates the indicator input device 61 to move at any direction of D1, D2, D3 and D4, the indicator on the computer screen 63 will also synchronously move at a corresponding direction of D1, D2, D3 and D4.

Please refer to FIG. 6B. When a user wishes to perform a body-sensing non-contact input operation, the user will let his/her hand move away from the body surface of the indicator input device 61, and when the hand is located at a suitable distance above the image recognition unit, the indicator input device 61 performs a non-contact input operation, so as to perform a body-sensing operation. Therefore, the computer host 62 can perform a corresponding input operation according to the operation instruction inputted by the indicator input device 61. For example, the indicator input device 61 can correspondingly generate a first, a second, a third, and a fourth operation instruction according to the moving directions of hand towards D1, D2, D3 and D4, while each operation instruction can correspondingly control the output picture on the computer screen 63, so as to perform a display control of previous page, next page, amplification or contraction. It should be noted that the above moving directions D1, D2, D3 and D4 and the corresponding operation instructions are only for exemplary illustration and not for limiting the present invention.

In addition, the indicator input device of the present invention may be a mouse, and the host may be a television device, a game device or a computer device.

Summing up the above, the indicator input device provided by the present device includes a non-contact input operation and a contact input operation, so as to let a user operate more conveniently and also let the user decrease the number of an input operation that depends on a keyboard or a touch screen.

The descriptions illustrated supra set forth simply the preferred embodiments of the present invention; however, the characteristics of the present invention are by no means restricted thereto. All changes, alterations, or modifications conveniently considered by those skilled in the art are deemed to be encompassed within the scope of the present invention delineated by the following claims.

What is claimed is:

1. An indicator input device with image recognition function, used for controlling the movement of an indicator displayed on a host, and including:
a body;
a displacement sensing unit, for detecting the movement of the body;
an image recognition unit, installed on the body; and
a control unit, coupled to the displacement sensing unit and the image recognition unit, and generating an indicator control signal to control the movement of the indicator according to the detection result of the displacement sensing unit, and generating an operation instruction corresponding to a body action according to the image recognition result of the image recognition unit.

2. The indicator input device according to claim 1, further including a memory unit, which is coupled to the control unit and stores a contrast table, the contrast table recording the corresponding relationship between the body action and the operation instruction.

3. The indicator input device according to claim 1, further including a switching unit, which is coupled to the control unit, the control unit controlling the image recognition unit to be enabled or disabled according to a switching signal outputted by the switching unit.

4. The indicator input device according to claim 3, wherein the switching unit is a switch or a switching button.

5. The indicator input device according to claim 3, wherein the switching unit is a distance sensor.

6. The indicator input device according to claim 3, wherein the switching unit is a light detector.

7. The indicator input device according to claim 1, wherein the operation instruction is outputted to the host and controls an output picture of the host to perform a display control of previous page, next page, scrolling, amplification and/or contraction.

8. The indicator input device according to claim 1, wherein the image recognition unit is an image sensor.

9. The indicator input device according to claim 1, wherein the indicator input device is a mouse.

10. The indicator input device according to claim 1, wherein the host is a television device, a game device or a computer device.
